(19) United States
(12) Patent Application Publication
(10) Pub. No.: US 2005/0213967 A1
(43) Pub. Date: Sep. 29, 2005

(54) Optical wavelength division multiplexing transmission system

(75) Inventors: Hisanori Okano, Yokohama (JP); Hiroyuki Iwaki, Yokohama (JP); Takanori Yasui, Yokohama (JP); Masato Hashizume, Yokohama (JP); Megumi Shibata, Kameoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/915,568

(22) Filed: Aug. 11, 2004

(30) Foreign Application Priority Data
Mar. 29, 2004 (JP) 2004-095908

(51) Int. Cl. H04B 10/08

(52) U.S. Cl. 398/30

(57) ABSTRACT

If wavelengths λa and λb are dropped in NE (Network Equipment) 2 and a wavelength λc is made Through, and all of wavelengths are made Through in NE3 in a certain time period, a route from NE1 to NE2, a route from NE2 to NE4, and a route from NE1 to NE4 are established. If a user who uses the wavelength λa from NE1 to NE2, and a user who uses the wavelength λb from NE2 to NE4 do not use the routes in another time period, and if another user desires to use a route from NE1 to NE3 and a route from NE3 to NE4, the routes are reestablished in a way such that the wavelength λa is converted into the wavelength λb and made Through in NE2, and the wavelength λb is dropped and added in NE3.

### BACKGROUND OF THE INVENTION

1. Field of the Invention

The present invention relates to an optical wavelength division multiplexing (WDM) transmission system.

2. Description of the Related Art

With the popularization of communications technology using a computer, the volume of traffic to be accommodated by a communications system has been rapidly increasing. As a system that can accommodate such traffic, an optical wavelength division multiplexing transmission system is known.

FIG. 1 exemplifies the general configuration of a wavelength division multiplexing transmission system.

An NE (Network Equipment) ion a transmitting side is configured by a MUX unit 10 multiplexing wavelengths λ1 to λn, a TA (Transmitting Amplifier) unit 11 optically amplifying a WDM optical signal output from the MUX unit 10, and an OSC (Optical Supervisory Channel) unit 12 conveying optical signal information, various items of OH (OverHead) information and device information. An OSC optical signal is multiplexed with an optical signal output from the TA 11, and output from the NE 1. The NE2 and an NE3 respectively comprise OSC units 15 and 16 receiving and transmitting an OSC optical signal, an RA (Receiving Amplifier) unit (not shown) optically amplifying WDM optical signals from all of NEs, and an XC (CrossConnect) unit 13 or 14 enabling some of the signals to be split and output, or to pass through, and also enabling input optical signals to be coupled. An NE4 is configured by an OSC unit 17 receiving an OSC optical signal, an RA unit 18 optically amplifying the signal further, and a DMUX unit 19 demultiplexing the signal into wavelengths λ1 to λn. This system includes systems transmitting an optical WDM signal to an opposite side each other. Since the configuration of the system transmitting an optical signal to the side opposite to the direction where the optical signal is transmitted is also similar to the above described configuration, its explanation is omitted.

As conventional optical WDM systems, Patent Documents 1 and 2 exist. Patent Document 1 discloses a WDM system forcibly releasing a wavelength path having a low priority, and establishing a wavelength path when the volume of traffic of a wavelength path of a user having a high priority becomes heavy. Patent Document 2 discloses an optical WDM system that can add a new line, and can effectively set up an unused line without affecting a line in use.

[Patent Document 1] Japanese Patent Publication No. 2002-135308

[Patent Document 2] Japanese Patent Publication No. 2003-174432

In conventional optical WDM systems, if there is a line that a user does not use in a particular time period or on a particular date and time, and if the line is considered to be made available to another user in the time period during which the line is unused, it cannot be used even if a user considers the use of a route other than an established route. This is because route setting for each wavelength is fixed.

FIG. 2 explains the conventional problem.

For example, if a user desires to use a route from the NE1 to the NE3, and a route from the NE3 to the NE4 in a time period during which another user who uses λa (A shown in FIG. 2) from the NE1 to the NE2, and λb (B shown in FIG. 2) from the NE2 to the NE4 does not use these wavelengths, these wavelengths cannot be used despite their existence.

### SUMMARY OF THE INVENTION

An object of the present invention is to provide a WDM transmission system that enables another user to use a line in a certain time period by contract, and also enables an arbitrary route setting by performing wavelength conversion depending on a time period in each NE.

An optical WDM transmission system according to the present invention is an optical wavelength division multiplexing transmission system, where a plurality of transmission devices are connected, wavelength-division multiplexing and transmitting a plurality of wavelengths. Each of the transmission devices is characterized in comprising a switching unit switching a path of an optical signal having each wavelength, a wavelength converting unit converting a wavelength of an optical signal, and a controlling unit converting a wavelength of an optical signal, switching a path, and transferring the optical signal based on information from a supervisory control signal in order to form a desired path by connecting unused paths in a predetermined time period.

According to the present invention, if a wavelength that is unused in a certain time period occurs by contract, this wavelength is allocated to another user, and wavelength-converted, whereby a route can be formed and made available to the other user. Accordingly, network resources can be effectively used, and a user can make a contract for the use fee of network resources depending on a time period, whereby the user does not need to pay an extra contract fee.

### DESCRIPTION OF THE DRAWINGS

FIG. 1 exemplifies a general configuration of a WDM transmission system;

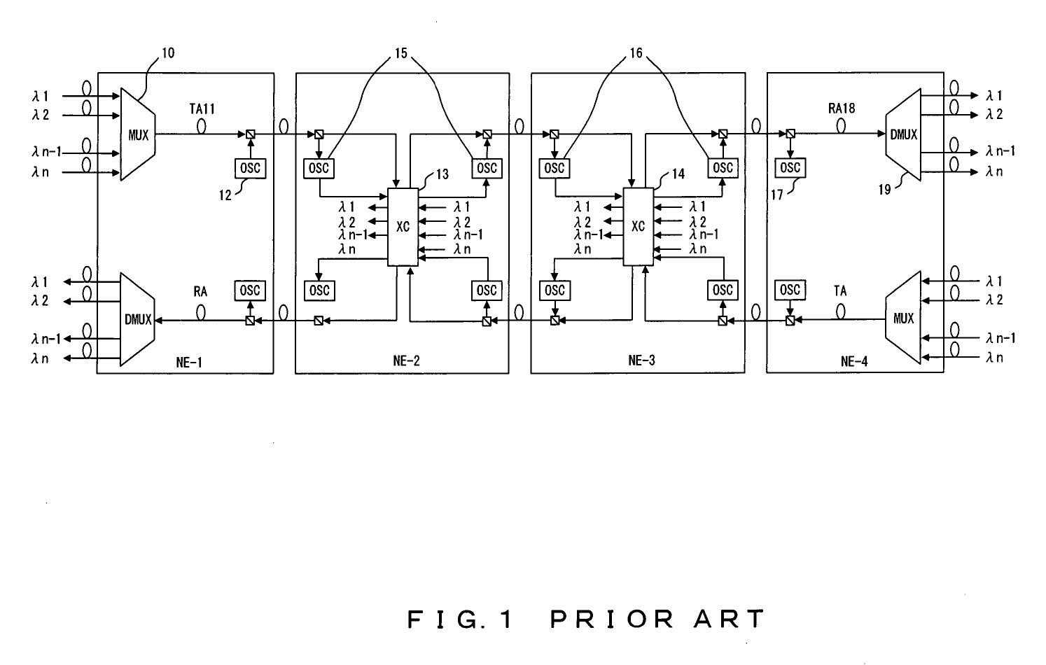

FIG. 2 explains a conventional problem;

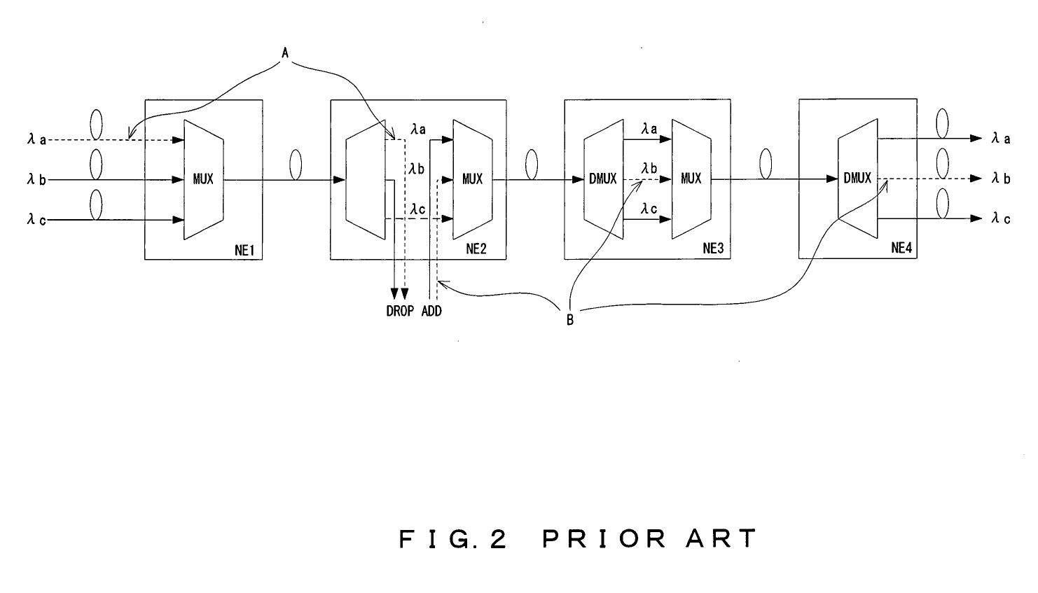

FIG. 3 explains the principle of a configuration implementing a preferred embodiment according to the present invention;

FIG. 4 shows the details of an XC unit according to the preferred embodiment of the present invention;

FIG. 5 explains the preferred embodiment according to the present invention;

FIG. 6 exemplifies an operation performed by the XC unit based on information from a management unit, according to the preferred embodiment of the present invention;

FIG. 7 shows a system configuration (No. 1) for implementing a first preferred embodiment according to the present invention;

FIG. 8 shows a system configuration (No. 2) for implementing the first preferred embodiment according to the present invention;

FIG. 9 is a flowchart showing operations performed in the case of FIGS. 7 and 8;

FIG. 10 shows and explains a system configuration for implementing a second preferred embodiment according to the present invention;

FIG. 11 is a flowchart explaining a process executed by a management NE;

FIG. 12 is a flowchart explaining a process executed by an NE to be managed;

FIG. 13 shows and explains a system configuration for implementing a third preferred embodiment according to the present invention;

FIG. 14 is a flowchart explaining a process executed by each NE, according to the third preferred embodiment;

FIG. 15 explains a system configuration and operations for implementing a fourth preferred embodiment according to the present invention;

FIG. 16 is a flowchart explaining a process executed by each NE, according to the fourth preferred embodiment of the present invention;

FIG. 17 is a flowchart showing the details of a process executed by an SW unit; and

FIG. 18 is a flowchart showing the operations of a wavelength converting unit.

### DESCRIPTION OF THE PREFERRED EMBODIMENTS

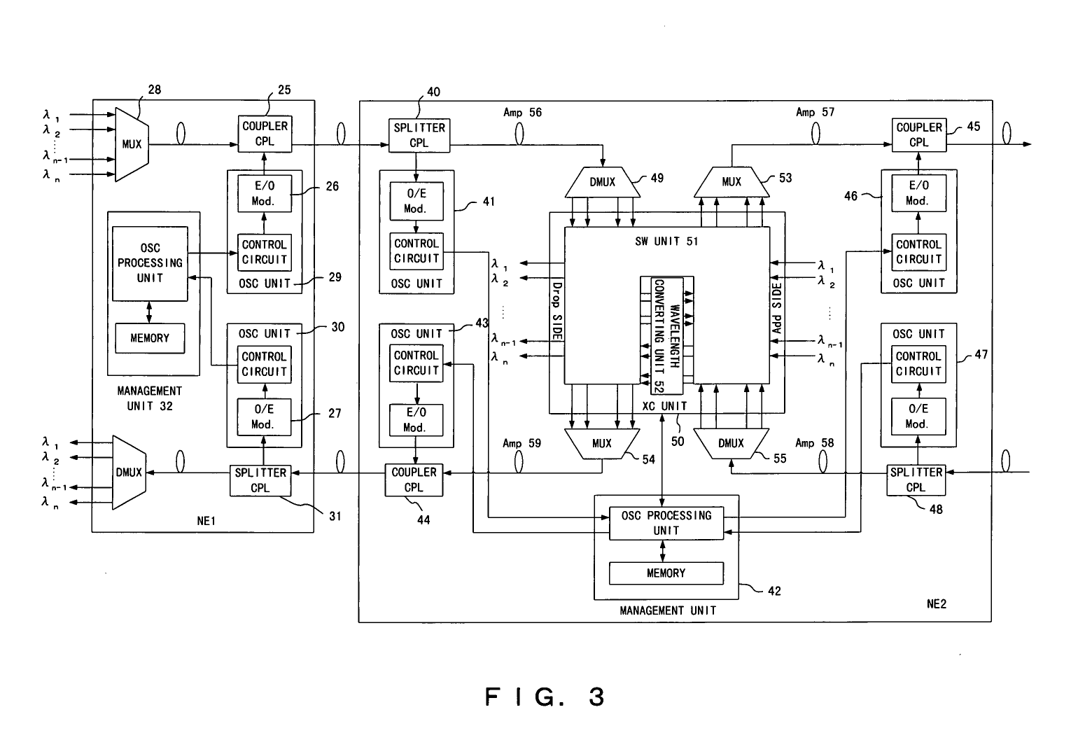

FIG. 3 explains the principle of a configuration implementing a preferred embodiment according to the present invention.

A coupler CPL 25 is a coupler coupling WDM and OSC optical signals having different wavelengths. An E/O Mod 26 is a module converting an electric signal into an optical signal, whereas an O/E Mod 27 is a module converting an optical signal into an electric signal. To an NE1 on a transmitting side, optical signals having wavelengths λ1 to λn are input, and multiplexed by a MUX unit 28, so that WDM light is generated. Furthermore, the WDM light is coupled with an OSC optical signal by the coupler CPL 25, and transmitted to a transmission path. For the OSC optical signal, a corresponding electric signal is first generated by an OSC processing unit of a management unit 32. The OSC processing unit generates an OSC signal with the electric signal based on various items of information stored in a memory, transmits the OSC signal to a control circuit of an OSC unit 29, which controls the E/O Mod 26 converting an electric signal into an optical signal, so that the OSC optical signal is generated. The OSC optical signal is coupled with a main signal by the coupler CPL. Additionally, a splitter CPL 31 on a receiving side splits an OSC optical signal from a transmitted optical signal, and transmits the split signal to the O/E Mod 27. Here, the optical signal is converted into an electric signal, and input to the OSC processing unit of the management unit 32 via a control circuit of an OSC unit 30. The OSC signal is processed here. Namely, information included in the OSC signal is analyzed based on information stored in the memory, and newly transmitted as an OSC optical signal from the transmitting side, or used to control the NE1.

An NE2 is a transmission device on the way of a transmission path. When a transmitted WDM optical signal enters the NE2, an OSC optical signal is split by a splitter CPL 40. After a main signal is amplified by an optical amplifier 56, it is demultiplexed into optical signals having respective wavelengths by a DMUX unit 49, and input to an XC unit 50. In the meantime, the OSC optical signal split by the splitter CPL 40 is converted into an electric signal by an OSC unit 41, and transmitted to a management unit 42. The management unit 42 analyzes information included in the OSC optical signal, transmits the information to the XC unit 50, and instructs the switching of an optical path, etc. The XC unit 50 has a function to perform any of Add, Drop, Through, and wavelength conversion operations based on the information from the OSC unit 41. A SW unit 51 is intended to change an optical path. The SW unit 51 switches the optical path of an optical signal input from the DMUX unit 49, outputs the signal to the Drop side or the side of the MUX unit 53 or 54, or input to a wavelength converting unit 52. Additionally, the SW unit 51 outputs the optical signal input from the Add side or from the DMUX unit 55 to the MUX unit 53 or 54, and outputs the optical signal input from the wavelength converting unit 52 to the MUX unit 53 or 54. After the optical signal output from the MUX unit 53 is amplified by an optical amplifier 57, it is coupled with the OSC optical signal by a coupler CPL 45, and transmitted to a transmission path. Also in an optical transmission system on the opposite side, an OSC optical signal is split by a splitter CPL 48, and converted into an electric signal by an OSC unit 47 in a similar manner. The electric signal is analyzed by the management unit 42, and used to control the operations of the XC unit 50. A main signal output from the splitter CPL 48 is amplified by an optical amplifier 58, demultiplexed into optical signals having respective wavelengths by a DMUX unit 55, and input to the XC unit. The respective optical signals output to the side of the MUX unit 54 are multiplexed, and amplified by an optical amplifier 59. The amplified signal is coupled with the OSC optical signal by a coupler CPL 44, and transmitted to a transmission path.

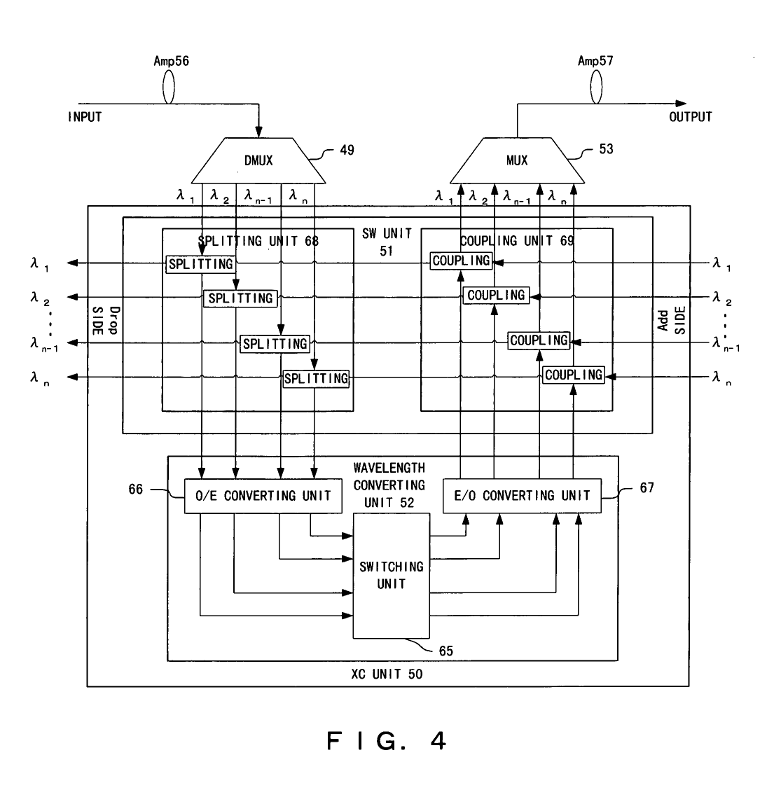

FIG. 4 shows the details of the XC unit according to the preferred embodiment of the present invention.

A WDM optical signal coming from the input side is amplified by the optical amplifier 56, and demultiplexed into optical signals having respective wavelengths by the DMUX unit 49. The demultiplexed optical signals are input to a branch unit 68 of the SW unit 51. The branch unit 68 transmits the optical signals to the Drop side or a coupling unit 69, or to the wavelength converting unit 52. In the wavelength converting unit 52, the optical signals having respective wavelengths are converted into electric signals by an O/E converting unit 66, output ports are switched by a switching unit 65, and the signals are converted into optical signals having wavelengths different from the original wavelengths by an E/O converting unit 67, and input to the coupling unit 69. In the coupling unit 69, the optical signal from the branch unit 68, the optical signal from the wavelength converting unit 52, and the optical signal from the Add side are output to the MUX unit 53. The MUX unit 53 multiplexes the optical signal having the respective wavelengths and transmits the multiplexed signal via the optical amplifier 57.

According to the preferred embodiment of the present invention, setting information such as Add/Drop/Through/wavelength conversion, etc. of an optical signal in each NE is managed for each time, and transmitted to an NE by using an OSC optical signal, and wavelength setting is made by controlling the XC unit of each NE, whereby an idle route varying depending on a time period is arbitrarily set.

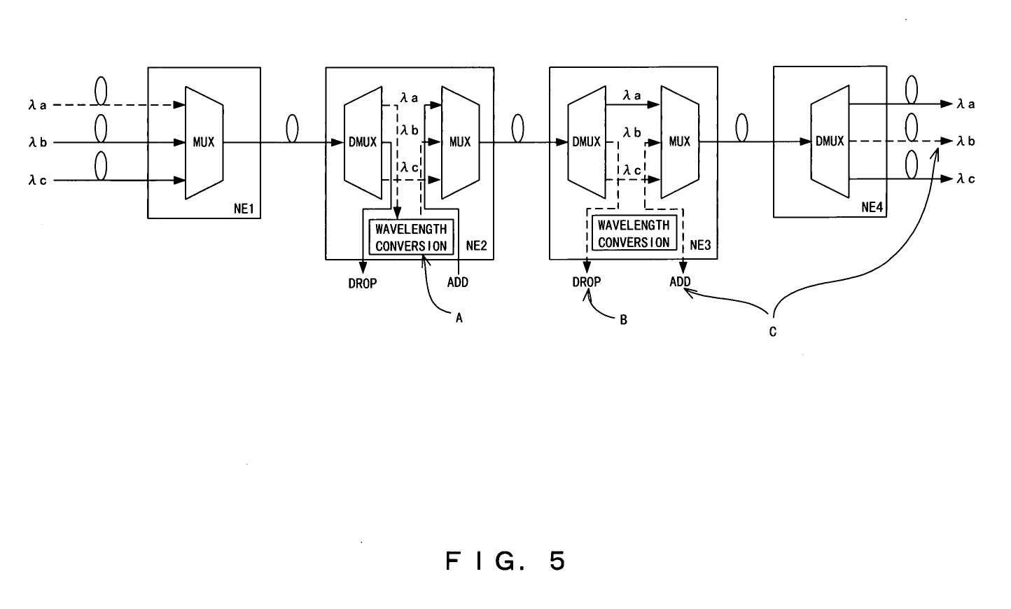

FIG. 5 explains the preferred embodiment according to the present invention.

In the preferred embodiment according to the present invention, as shown in FIG. 5, an optical signal having a wavelength λa from the NE1 to the NE 2 is wavelength-converted into a wavelength λb (A shown in FIG. 5) in a certain time period, and transmitted by using an optical signal having the wavelength λb from the NE2 to the NE3 (C shown FIG. 5). In this way, the wavelength of an optical signal having an available wavelength in a certain time period is switched, and a route on which the signal is transmitted is allowed to be arbitrarily set to another route only in that time period. In this way, a user who desires to temporarily use various routes can also be flexibly supported.

In this preferred embodiment, unlike conventional methods, a wavelength that is not used during a certain time period is released to another user, thereby reducing communications cost, and route settings with a higher degree of arbitrariness can be made by switching a wavelength. As a result, a user who desires various routes can also be flexibly supported, and a service with a higher degree of arbitrariness can be provided.

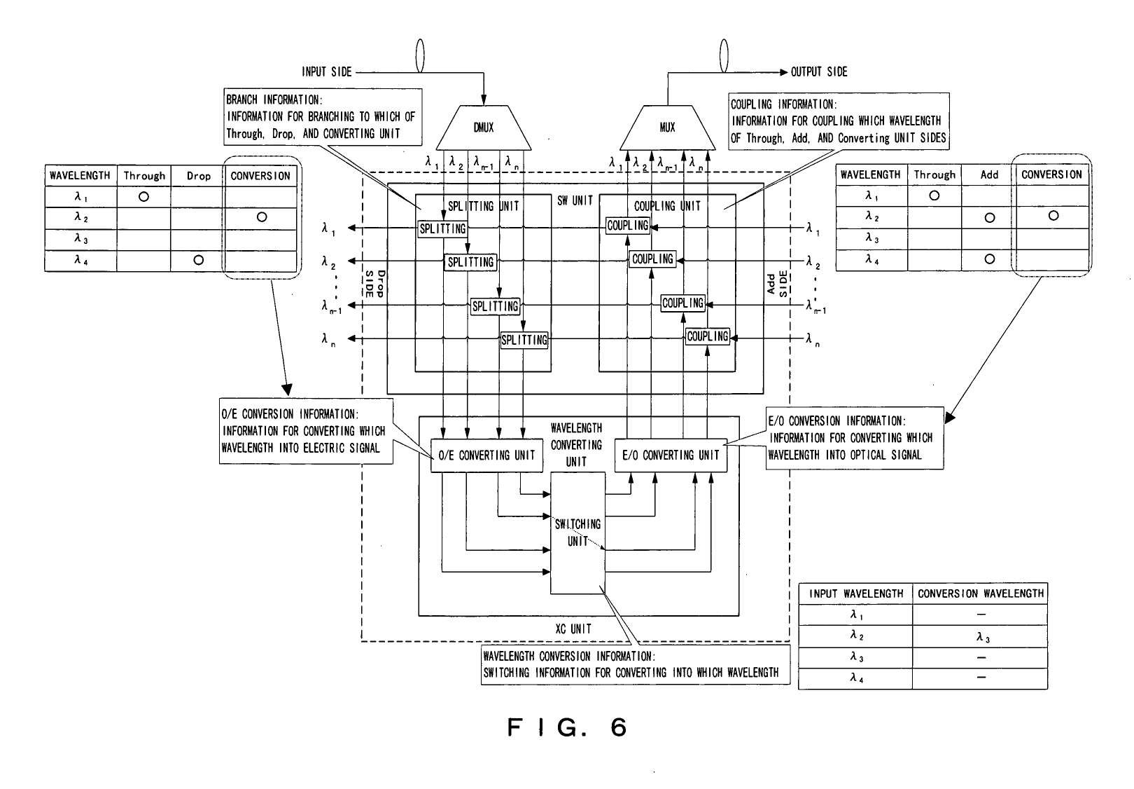

FIG. 6 exemplifies the operations performed by the XC unit based on the information from the management unit, according to the preferred embodiment of the present invention.

The information from the management unit instructs that optical signals having respective wavelengths are to be branched to any of the Through, Drop, and converting units in the branch unit. Additionally, in the coupling unit, the information from the management unit instructs that an optical signal having a wavelength from one of the Through, Add, and converting units is to be coupled. Furthermore, the information from the management unit is used as information for converting a wavelength into an electric signal as O/E conversion information, information for converting a wavelength into an electric signal, namely, switching information for outputting a signal from an input port to an output port as wavelength conversion information, or information for a line to which conversion into an optical signal is made as E/O conversion information in the wavelength converting unit.

That is, the switching of the XC unit is controlled by the information from the OSC unit. This information is described.

The switching is implemented by transmitting line setting information from the management unit to the XC unit in a set time period T1. The line setting information falls into the branch information and coupling information for controlling the SW unit, the O/E conversion information and the E/O conversion information for controlling the wavelength converting unit, and the conversion information for converting into a wavelength.

The branch unit branches λx input from the DMUX unit based on received branch information. In the case of Through, λx is branched to the coupling unit. In the case of Drop, λx is branched to the Drop side. In the case of wavelength conversion, λx is branched to the wavelength converting unit.

The coupling unit transmits λx to the MUX unit based on received coupling information. In the case of Through, λx from the branch unit is coupled. In the case of Add, λx on the Add side is coupled. In the case of wavelength conversion, λx from the wavelength converting unit is coupled.

The wavelength converting unit converts the input wavelength λx into another wavelength λy according to the received O/E conversion information, E/O conversion information, and conversion information. λx input from the branch unit is converted into an electric signal Ex according to the O/E conversion information by the O/E converting unit. The converted electric signal Ex is switched to the E/O converting unit converting into the optical signal λy according to the conversion information by the switching unit. The electric signal Ex input to the E/O converting unit converting into λy is converted into the optical signal λy according to the E/O conversion information, and transmitted to the SW unit.

A case where the wavelength λ1 on the input side is made Through to the output side, and λ2 on the input side is converted into λ3 on the output side and made Through, the wavelength λ2 on the output side is added, and λ4 on the input side is dropped and added to the output side is explained.

Branch information is transmitted to the branch unit, and λ1, λ2, and λ4 are respectively branched to the coupling unit, the side of the converting unit, and the Drop side according to the information. Coupling information is transmitted to the coupling unit, and λ1 from the branch unit, λ2 from the Add side, λ3 from the side of the converting unit, and λ4 from the Add side are coupled to the MUX unit according to the information.

In the wavelength converting unit, O/E conversion information is transmitted to the O/E converting unit, and λ2 is converted into an electric signal. Wavelength conversion information is transmitted to the switching unit, and the electric signal converted from λ2 is transmitted to the E/O converting unit converting into λ3. E/O conversion information is transmitted to the E/O converting unit, which converts the electric signal into an optical signal having a wavelength λ3.

These items of information are transmitted to make a set switching at a preset time, whereby a switching operation based on time is performed.

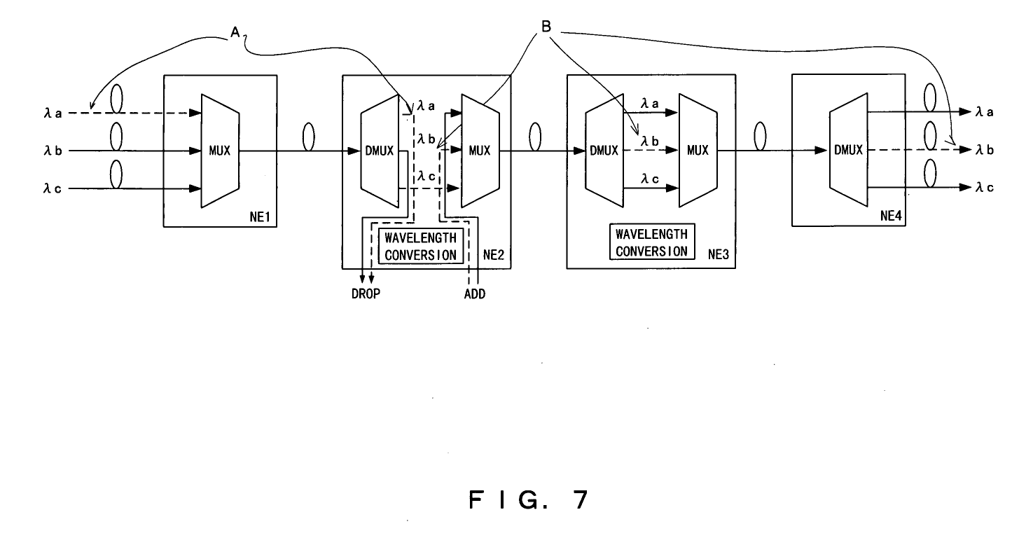

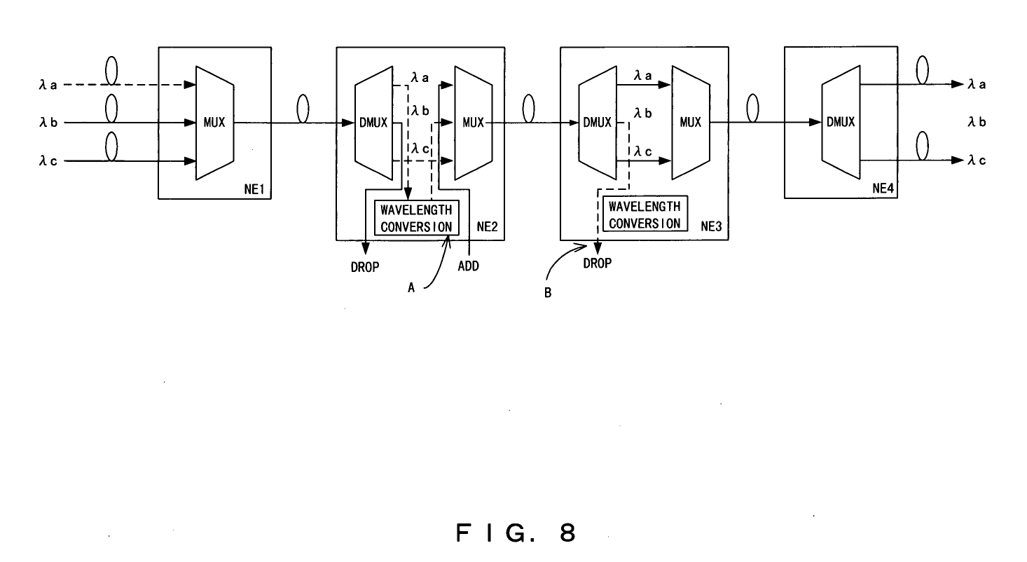

FIGS. 7 and 8 show system configurations for implementing a first preferred embodiment according to the present invention.

An XC unit having a wavelength conversion function exists in each of NEs. A user α1 (A shown in FIG. 7) who uses a wavelength λa from the NE 1 to the NE 2, and a user α2 (B shown in FIG. 7) who uses a wavelength λb from the NE 2 to the NE 4 exist in a time period T1. If a user β1 desires to use a route from the NE1 to the NE3 in a time period T2 during which the users α1 and α2 do not use the corresponding wavelengths, the XC unit of the NE2 wavelength-converts λa received from the NE1 into λb, and transmits λb to the NE3 (A shown in FIG. 8) in order to secure the route from the NE1 to the NE3. The NE3 drops λb received from the NE2 (B shown in FIG. 8). When the time period T1 during which the users α1 and α2 uses the wavelengths is reached, the settings are restored to the original ones. Also the settings from the NE4 to the NE1 are similar to the above described ones.

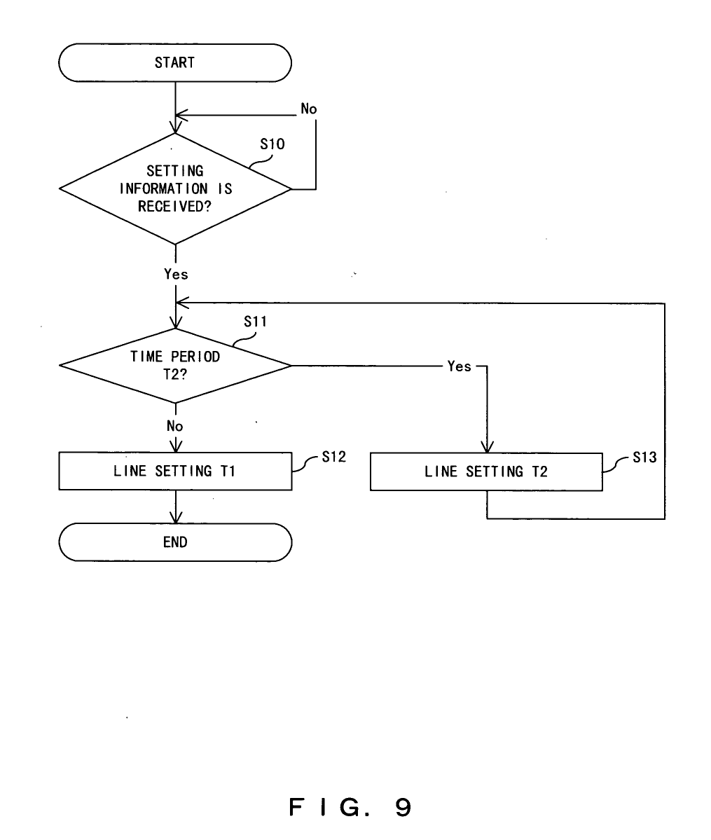

FIG. 9 is a flowchart showing operations performed in the case of FIGS. 7 and 8.

The following process is a process executed by the management unit.

In step S10, the management unit determines whether or not setting information is received. If the setting information is determined not to be received in step S10, the setting information is waited to be received. If the setting information is determined to be received in step S10, the management unit determines whether or not a time period T2 during which line setting is to be switched is reached. If the time period T2 is determined not to be reached, the original line setting T1 is made in step S12, and the process is terminated. If the time period T2 is determined to be reached in step S11, line setting T2 is made in step S13, and the process goes back to step S11. The line setting T2 is maintained until the time period T2 expires.

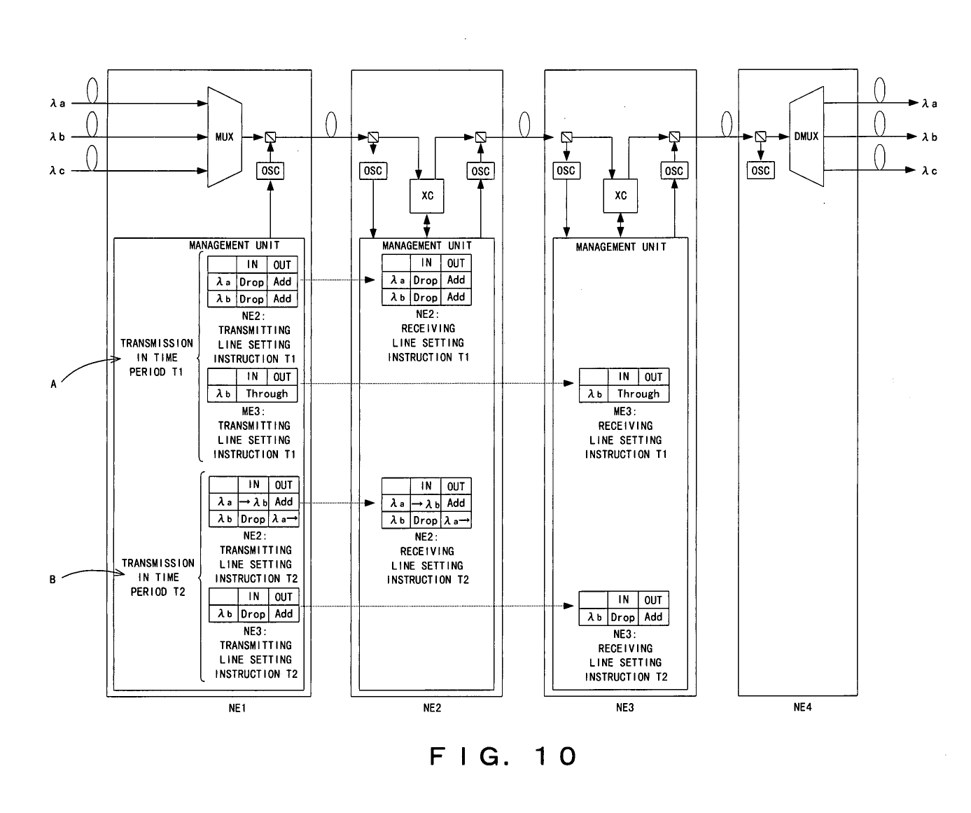

FIG. 10 shows and explains a system configuration for implementing a second preferred embodiment according to the present invention.

An NE1 set as a management NE transmits a wavelength setting instruction to all of NEs by using an OSC signal, whereby the wavelengths of the NEs are altogether set. If a user α1 who uses a route from the NE1 to an NE2, and a user α2 who uses a route from the NE2 to an NE4 exist in a time period T1, and if a user β1 who uses a route from the NE1 to an NE3, and a user β2 who uses a route from the NE3 to the NE4 exist in a time T2, the NE1 set as the management NE transmits a line setting instruction T1 (A shown in FIG. 10) to the NE2 and the NE3, which are to be managed, by using an OSC signal. The NE2 sets λa and λb to Add/Drop according to the received setting instruction to Add/Drop (λc is always Through). The NE3 sets λb to Through according to the received setting instruction (λa and λc are always Through). In this way, the settings of the time period T1 are completed. When the time period T2 is reached, the NE1 transmits a line setting instruction T2 (B shown in FIG. 10) to the NE2 and the NE3 by using an OSC signal. The NE2 wavelength-converts the received λa into λb according to the setting instruction, and transmits λb to the NE3. Namely, λb is dropped, and the added wavelength λa is converted into λb. The NE3 sets λb to Add/Drop according to the setting instruction. Also the settings from the NE4 to the NE1 are similar to the above described ones.

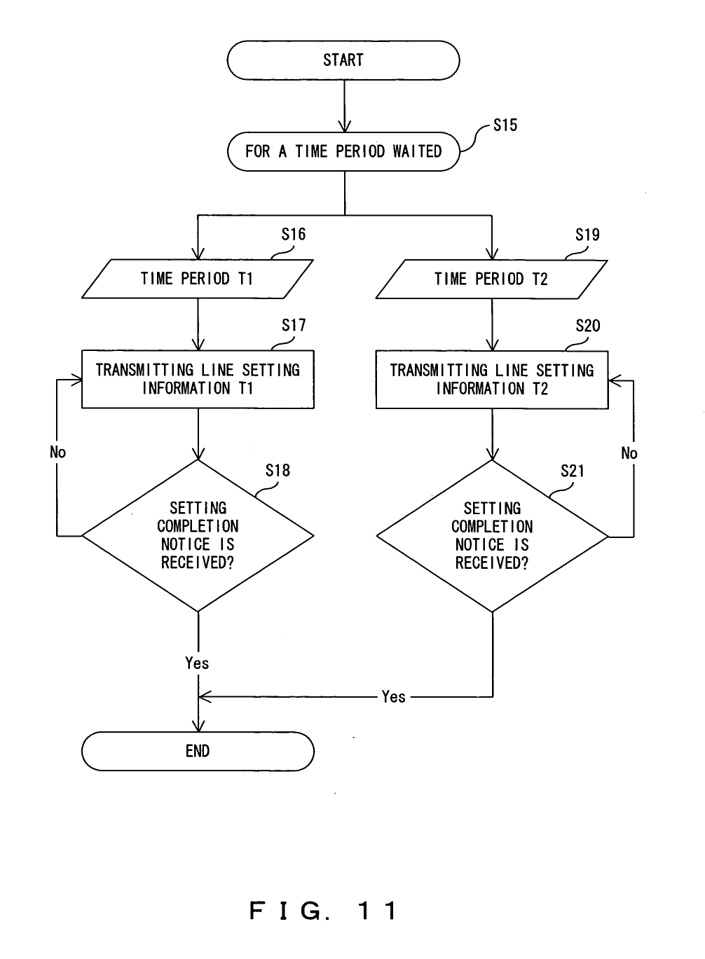

FIG. 11 is a flowchart explaining the process executed by the management NE.

The following process is the process executed by the management unit.

In step S15, a time period is waited. If the time period T1 is determined to be reached in step S16, the line setting information T1 is transmitted in step S17. Then, in step S18, it is determined whether or not a setting completion notification is received. If the setting completion notification is determined not to be received in step S18, the process goes back to step S17 where the line setting information T1 is retransmitted. If the setting completion notification is determined to be received in step S18, the process is terminated. If the time period T2 is determined to be reached in step S19, the line setting information T2 is transmitted in step S20. Then, in step S21, it is determined whether or not a setting completion notification is received. If the setting completion notification is determined not to be received in step S21, the process goes back to step S20 where the line setting information T2 is retransmitted. If the setting completion notification is determined to be received in step S21, the process is terminated.

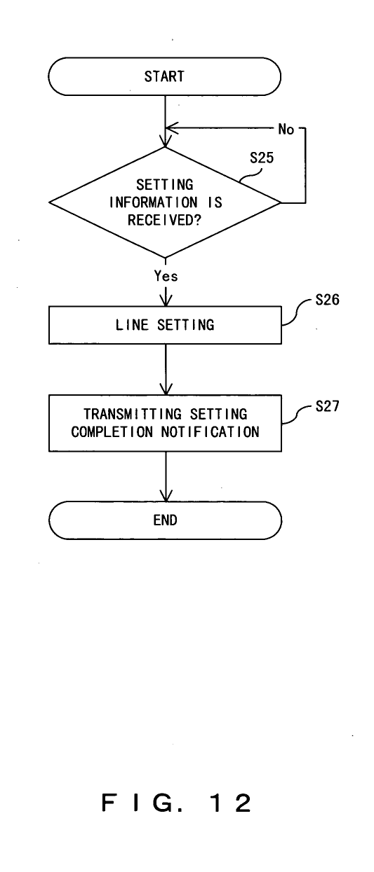

FIG. 12 is a flowchart explaining a process executed by an NE to be managed.

The following process is the process executed by the management unit.

In step S25, it is determined whether or not setting information is received. If the setting information is determined not to be received in step S25, the setting information is waited to be received. If the setting information is determined to be received in step S25, line setting is made in step S26. Then, in step S27, a setting completion notification is transmitted, and the process is terminated.

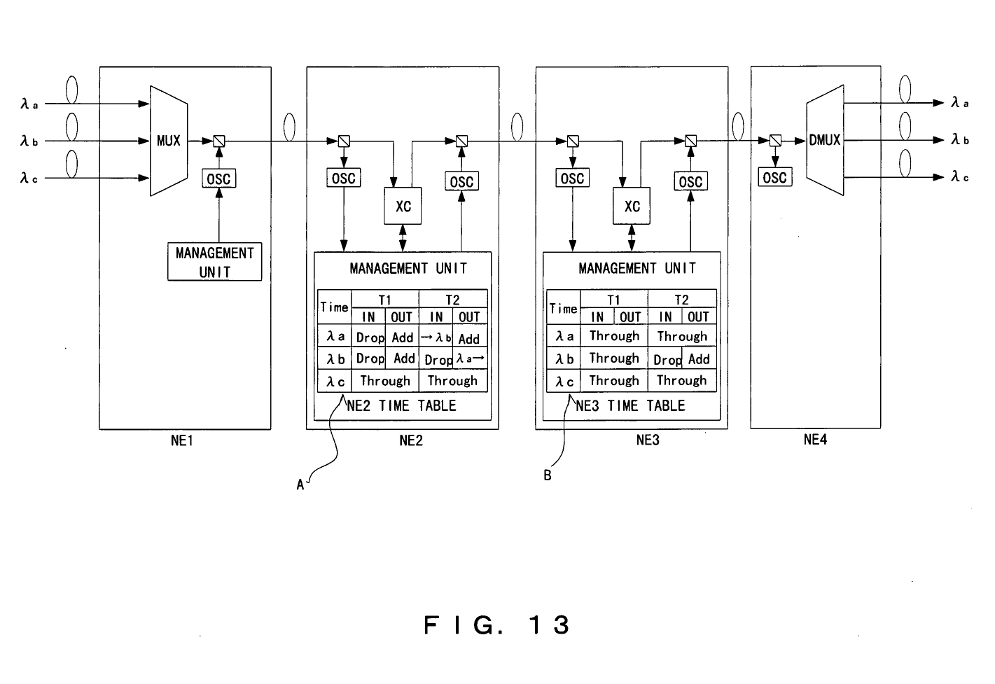

FIG. 13 shows and explains a system configuration for implementing a third preferred embodiment according to the present invention.

A time table of setting information is preset in each of the NEs. Each of the NEs individually makes wavelength settings according to this time table, whereby the wavelengths of the NEs are altogether set. If a user α1 who uses a route from the NE1 to the NE2, and a user α2 who uses a route from the NE2 to the NE4 exist in a time period T1, and if a user β1 who uses a route from the NE1 to the NE3, and a user β2 who uses a route from the NE3 to the NE4 exist in the time period T2, each of the NEs makes wavelength settings according to the time table in the time period T1. The NE2 sets λa and λb to Add/Drop, and also sets λc to Through according to a time table (A shown in FIG. 13). The NE3 sets λa, λb, and λc to Through according to a time table (B shown in FIG. 13). As a result, the settings of the time period T1 are completed. When the time period T2 is reached, each of the NEs makes wavelength settings according to a set time table. The NE2 wavelength-converts λa into λb, transmits λb to the NE3, drops λb, and adds λa according to the time table (A shown in FIG. 13). The NE3 sets λb to Add/Drop, and also sets λa and λc to Through according to the time table (B shown in FIG. 13). Also the settings from the NE4 to the NE1 are similar to the above described ones. The settings of a time table in each of the NEs can be changed from all of the NEs by using an OSC optical signal.

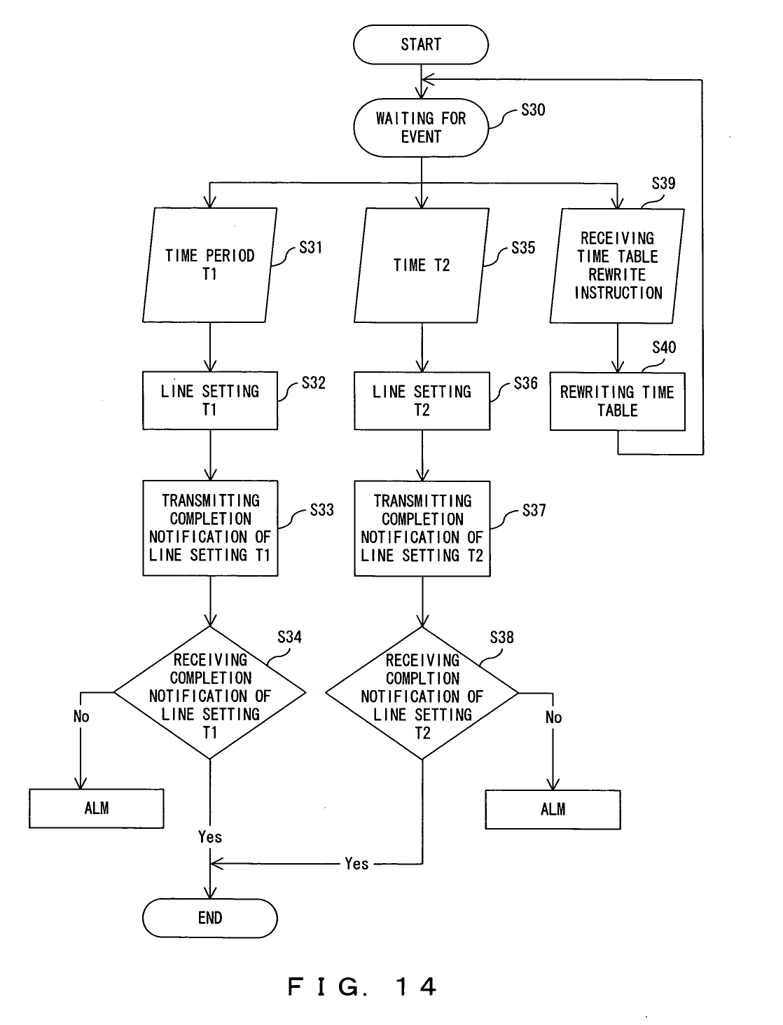

FIG. 14 is a flowchart explaining the process executed by each NE according to the third preferred embodiment.

Step S30 is waiting for an event to occur. If the time period T1 is determined to be reached in step S31, the line setting T1 is made in step S32. Then, in step S33, a completion notification of the line setting T1 is transmitted to the management NE. In step S34, it is determined whether or not the completion notification of the line setting T1 is received. If the completion notification is determined to be received in step S34, the process is terminated. If the completion notification is determined not to be received, an alarm is given. If the time period T2 is determined to be reached as in step S35, the line setting T2 is made in step S36. In step S37, a completion notification of the line setting T2 is transmitted. In step S38, it is determined whether or not the completion notification of the line setting T2 is received. If the completion notification is determined to be received, the process is terminated. If the completion notification is determined not to be received, an alarm is given. If a time table rewrite instruction is received as in step S39, the time table is rewritten in step S40, and the process goes back to step S30.

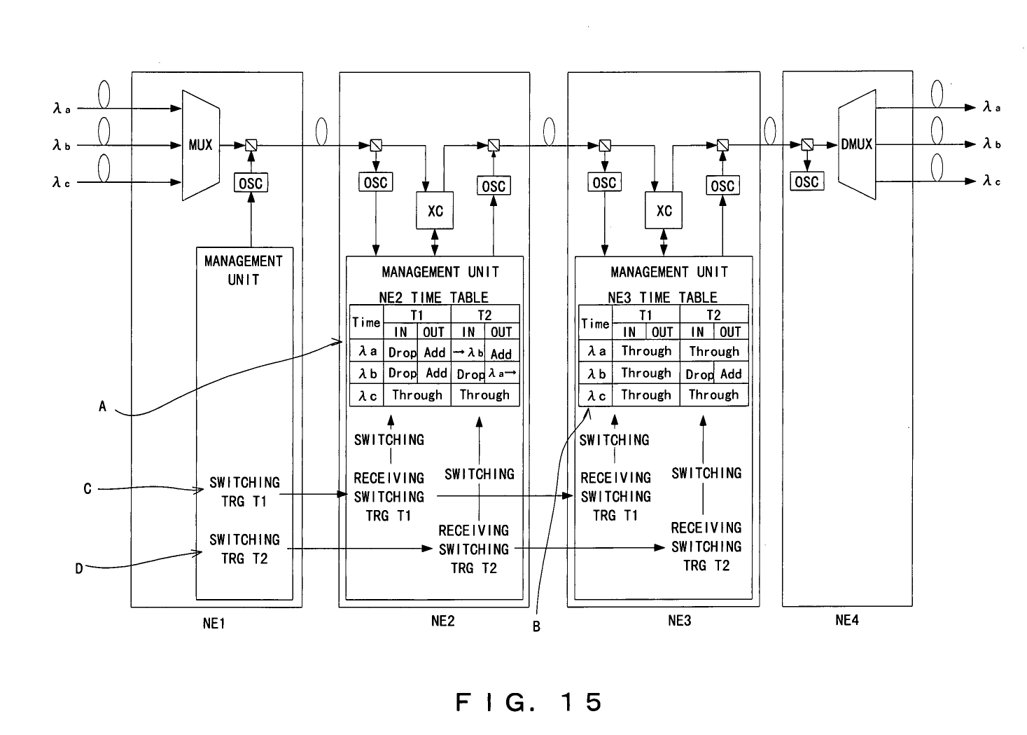

FIG. 15 shows and explains a system configuration and operations for implementing a fourth preferred embodiment according to the present invention.

A time table of setting information is preset in each of NEs. An NE1 set as a management NE transmits a switching trigger to all of the NEs by using an OSC optical signal, whereby the NEs altogether set wavelengths according to a time table. If a user α1 who uses a route from the NE1 to the NE2, and a user λ2 who uses a route from the NE2 to the NE4 exist in a time period T1, and if a user β1 who uses a route from the NE1 to the NE3, and a user β2 who uses a route from the NE3 to the NE4 exist in a time period T2, the NE1 set as the management NE transmits a switching trigger TRG1 (C shown in FIG. 15) to the respective NEs by using an OSC optical signal in the time period T1, and the respective NEs make wavelength settings by using the trigger as a cue according to the set time table. The NE2 sets λa and λb to Add/Drop, and also sets λc to Through according to a time table (A shown in FIG. 15). The NE3 sets λa, λb, and λc to Through according to a time table (B shown in FIG. 15). In this way, the settings of the time period T1 are completed. When the time period T2 is reached, the NE1 set as the management NE transmits a switching trigger TRG2 (D shown in FIG. 15) to the respective NEs by using an OSC optical signal, and the respective NEs make wavelength settings by using the trigger as a cue according to a set time table. The NE2 wavelength-converts λa into λb, transmits λb to the NE3, drops λb, and adds λa according to a time table (A shown in FIG. 15). The NE3 sets λb to Add/Drop, and also sets λb and λc to Through according to a time table (B shown in FIG. 15). Also the settings from the NE4 to the NE1 are similar to the above described ones. The settings of a time table in each of the NEs can be changed from all of the NEs by using an OSC optical signal.

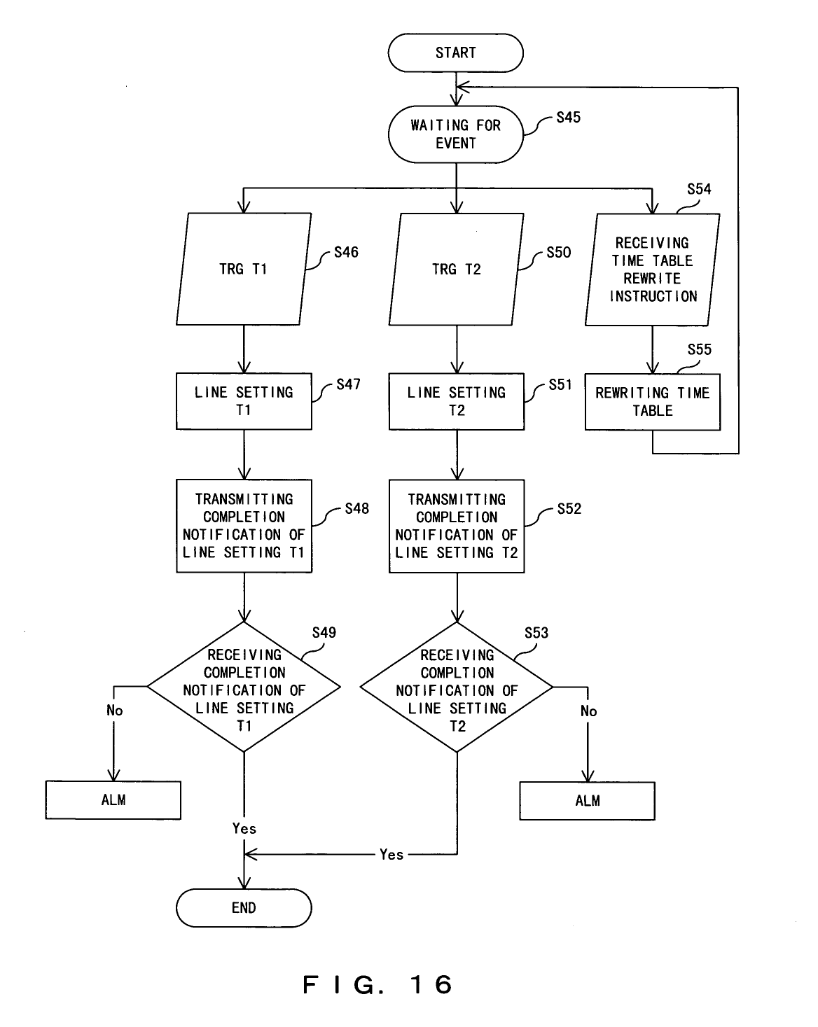

FIG. 16 is a flowchart explaining the process executed by each NE according to the fourth preferred embodiment of the present invention.

Step S45 is waiting for an event to occur. If the trigger TRG T1 is received as in step S46, the line setting T1 is made in step S47. Then, in step S48 a completion notification of the line setting T1 is transmitted. In step S49, it is determined whether or not the completion notification of the line setting T1 is received. If the completion notification is determined not to be received, an alarm is given. If the completion notification is determined to be received, the process is terminated.

If the trigger TRG T2 is determined to be received as in step S50, the line setting T2 is made in step S51. Then, in step S52, a completion notification of the line setting T2 is transmitted. In step S53, it is determined whether or not the completion notification of the line setting T2 is received. If the completion notification is determined to be received, the process is terminated. If the completion notification is determined not to be received, an alarm is given. If a time table rewrite instruction is received as in step S54, the time table is rewritten in step S55, and the process goes back to step S45.

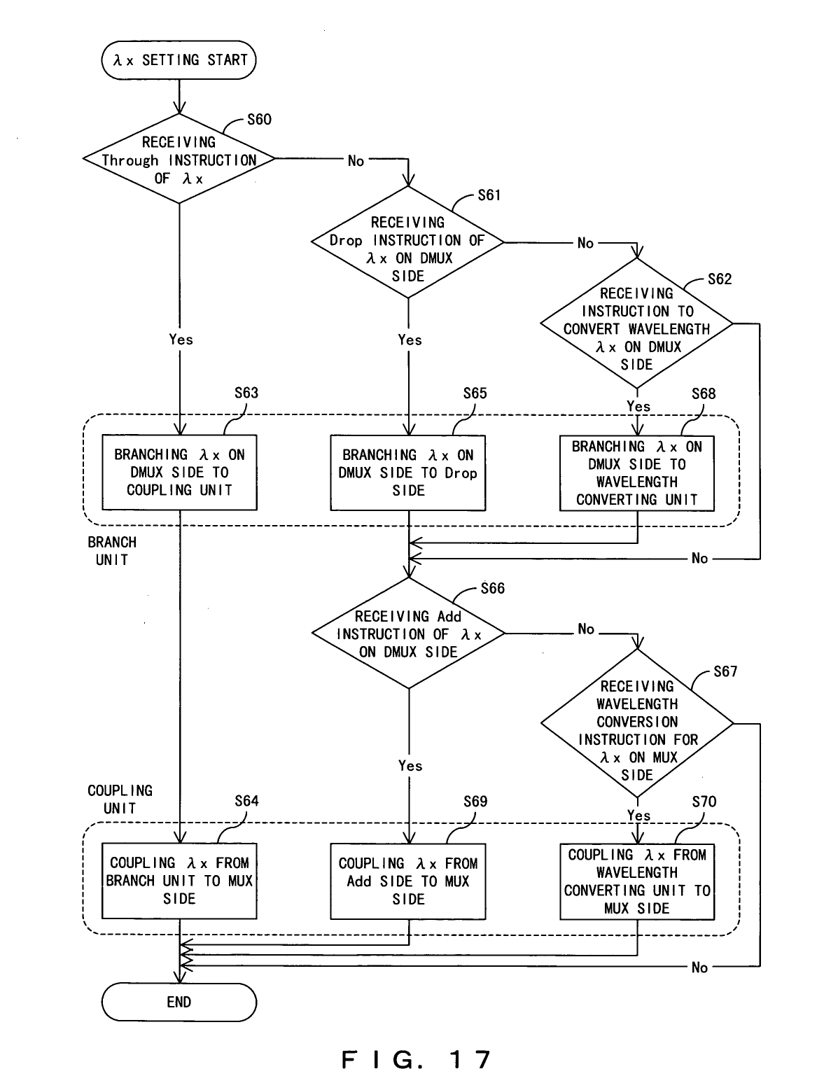

FIG. 17 is a flowchart showing the details of a process executed by the SW unit.

When the setting of the wavelength λx is started, it is determined in step S60 whether or not a Through instruction of λx is received. If the Through instruction is determined to be received, λx on the DMUX side is branched to the coupling unit in step S63, and λx from the branch unit is coupled to the MUX side in step S64. Here, the process is terminated.

If the Through instruction is determined not to be received in step S60, it is further determined in step S61 whether or not a Drop instruction of λx on the DMUX side is received. If a result of the determination made in step S61 is “Yes”, λx on the DMUX side is branched to the Drop side in step S65. Then, in step S66, it is determined whether or not an Add instruction of λx on the MUX side is received. If a result of the determination made in step S66 is “Yes”, λx from the Add side is coupled to the MUX side in step S69, and the process is terminated. If the result of the determination made in step S66 is “No”, it is determined in step S67 whether or not a wavelength conversion instruction for λx on the MUX side is received. If the instruction is determined to be received, λx from the wavelength converting unit is coupled to the MUX side in step S70. If the instruction is determined not to be received, the process is terminated.

If the Drop instruction is determined not to be received in step S61, it is determined in step S62 whether or not a wavelength conversion instruction for λx on the DMUX side is received. If a result of the determination made in step S62 is “Yes”, λx on the DMUX side is branched to the wavelength converting unit. If the result of the determination made in step S62 is “No”, the process goes to step S66.

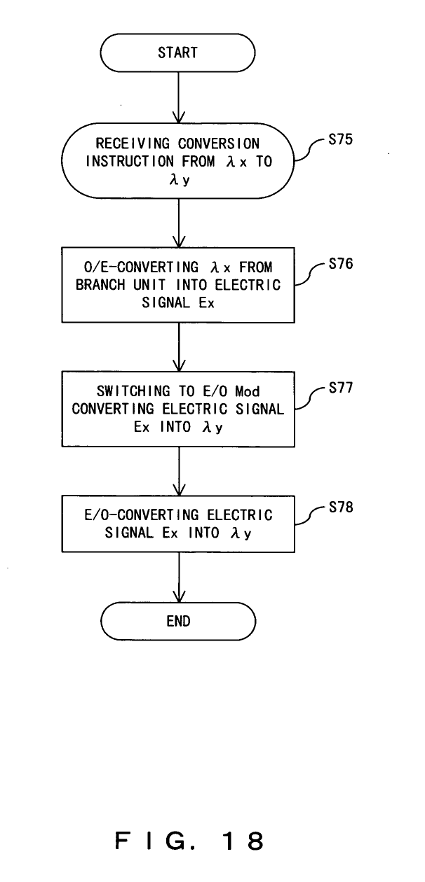

FIG. 18 is a flowchart explaining the operations of the wavelength converting unit.

In step S75, it is determined whether or not an instruction to convert the wavelength λx into λy is received. In step S76, λx from the branch unit is converted into an electric signal Ex by the O/E Mod. In step S77, an electric path is switched to the E/O Mod converting the electric signal Ex into λy. In step S78, the electric signal Ex is converted into λy by the E/O Mod, and the process is terminated.

1. An optical wavelength division multiplexing transmission system, where a plurality of transmission devices are connected, wavelength division multiplexing and transmitting a plurality of wavelengths, each of the plurality of transmission devices comprising:
a switching unit switching a path of an optical signal having each wavelength;
a wavelength converting unit converting a wavelength of an optical signal; and
a controlling unit converting a wavelength of an optical signal, switching a path, and transferring the optical signal based on information from a supervisory control signal in order to form a desired path by connecting unused paths in a predetermined time period.

2. The optical wavelength division multiplexing transmission system according to claim 1, wherein
said control unit comprises a memory unit storing setting information of wavelengths.

3. The optical wavelength division multiplexing transmission system according to claim 2, wherein
the setting information of wavelengths is transmitted from a predetermined transmission device to all of the other transmission devices.

4. The optical wavelength division multiplexing transmission system according to claim 2, wherein when a predetermined time period based on a time table also stored by said memory unit is reached, each of the transmission devices automatically executes a process for converting a wavelength, and for switching a path based on the setting information of wavelengths.

5. The optical wavelength division multiplexing transmission system according to claim 2, wherein
each of the transmission devices automatically executes a process for converting a wavelength, and for switching a path according to a trigger signal transmitted from a predetermined transmission device based on the setting information of wavelengths.
